(19) United States
(12) Patent Application Publication
(10) Pub. No.: US 2015/0019312 A1
(43) Pub. Date: Jan. 15, 2015

(54) MAGNETIC STRIPE CARDS

(71) Applicant: Ultralight Optics, Inc., Costa Mesa, CA (US)

(72) Inventor: Ronald C. NGUYEN, Fountain Valley, CA (US)

(21) Appl. No.: 14/301,339

(22) Filed: Jun. 11, 2014

Related U.S. Application Data
(60) Provisional application No. 61/834,144, filed on Jun. 12, 2013.

(51) Int. Cl. G06K 19/06; G06Q 30/02

(52) U.S. Cl. CPC G06K 19/06196; G06Q 30/0214
USPC 705/14.16; 235/493

(57) ABSTRACT

Magnetic stripe cards configured to be coupled to a ferromagnetic material are described. In one embodiment, a magnetic stripe card may include a substrate, a magnetic stripe coupled to the substrate, and at least one magnet coupled to the substrate. The magnet may have a magnetic pull force equal to or greater than that necessary to support a total weight of the substrate, the magnetic stripe, and the magnet when coupled to the ferromagnetic material.

### CROSS-REFERENCE TO RELATED APPLICATION

This application claims the benefit of U.S. provisional patent application Ser. No. 61/834,144, filed Jun. 12, 2013, which is hereby incorporated by reference in its entirety.

### BACKGROUND

Magnetic stripe cards such as gift cards, discount cards, and other cards may be put away out of sight, misplaced, or not easily located.

Dentists, physicians, and other healthcare professionals may wish to encourage existing patients to refer new patients. Also, businesses and professionals in other fields may wish to encourage existing customers to refer new customers.

What is needed are magnetic stripe cards which may be attached to a refrigerator door or other high traffic area for increased visibility.

What is needed are systems and methods for rewarding referrals to encourage existing patients and customers to refer new patients and customers.

### SUMMARY

Magnetic stripe cards configured to be coupled to a ferromagnetic material are described. In one embodiment, a magnetic stripe card may comprise a substrate, a magnetic stripe coupled to the substrate, and at least one magnet coupled to the substrate. The magnet may have a magnetic pull force equal to or greater than that necessary to support a total weight of the substrate, the magnetic stripe, and the magnet when coupled to the ferromagnetic material.

Systems for rewarding referrals are described. In one embodiment, a system comprises a first card having a first coupon associated with the first card. The first coupon is not initially available for use. The system also comprises a second card associated with the first card. The second card has a second coupon associated with the second card. Use of the second coupon associated with the second card causes the first coupon associated with the first card to become available for use.

Methods for rewarding referrals are described. In one embodiment, a method comprises receiving a first identifier associated with a first card. The first card is associated with a first coupon. The first coupon is not initially available for use. The method also comprises receiving a second identifier associated with a second card. The second card is associated with a second coupon. The method also comprises associating the first card with the second card, receiving a notice that the second coupon associated with the second card has been used, and making the first coupon associated with the first card available for use.

### BRIEF DESCRIPTION OF THE DRAWINGS

FIGS. 1A-1B show one embodiment of a magnetic stripe card 100.

FIGS. 2A-2B show another embodiment of a magnetic stripe card 200.

FIGS. 3A-3B show yet another embodiment of a magnetic stripe card 300.

FIGS. 4A-4B show one embodiment of a backing 400 coupled to magnetic stripe card 100.

FIG. 5 shows one embodiment of a system 500 for rewarding referrals.

FIG. 6 shows another embodiment of a system 600 for rewarding referrals.

### DESCRIPTION

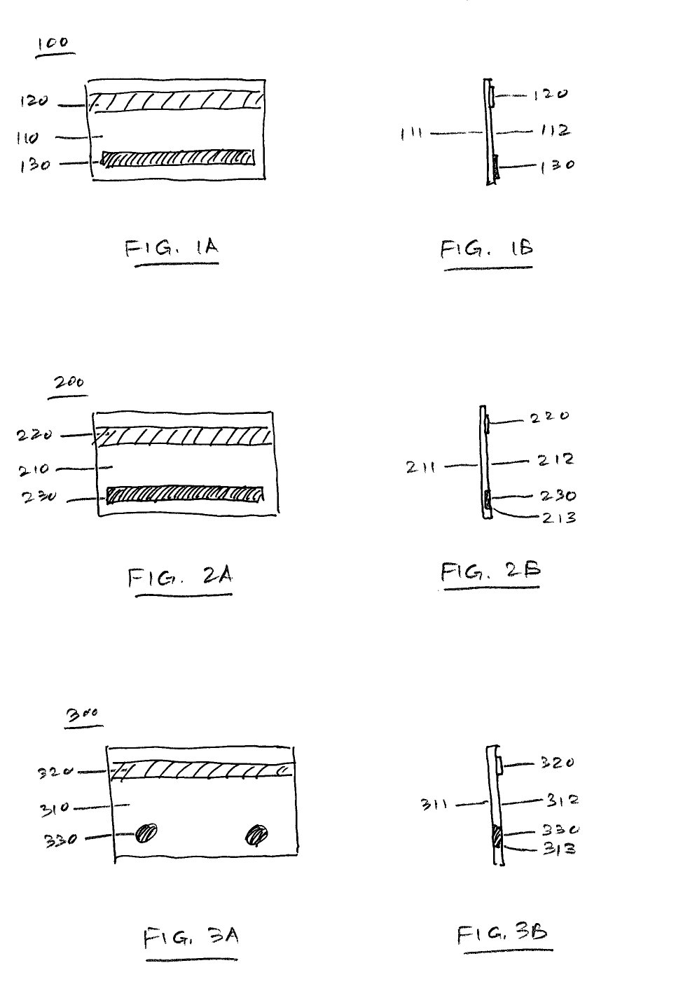

FIGS. 1A-1B show one embodiment of a magnetic stripe card 100. Magnetic stripe card 100 may be a gift card, credit card, debit card, stored value card, identification card, or any other card having a magnetic stripe. Magnetic stripe card 100 may include a substrate 110, a magnetic stripe 120, and at least one magnet 130.

Substrate 110 may be substantially flat. Substrate 110 may include a front side 111 and a back side 112. Substrate 110 may be substantially rectangular. Alternatively, substrate 110 may be any other suitable shape. Substrate 110 may be printed, embossed, and/or otherwise imparted with a business name, advertisement, account number, bar code, graphics, value indication, writeable area, and/or any other desired information. Substrate 110 may be rigid, semi-rigid, or flexible. Substrate 110 may be made of a plastic, metal, cardboard, paper, and/or any other suitable material.

Substrate 110 may have dimensions that substantially conform to CR80 or ISO/IEC 7810 ID-1. Substrate 110 may have dimensions of a standard credit card, or having a length and width of approximately 85.60 mm×53.98 mm and a thickness of approximately 0.76 mm. For at least some applications, the size of substrate 110 may be important as it may give magnetic stripe card 100 a higher perceived value than cards or tokens of other sizes. Alternatively, substrate 110 may have any suitable dimensions.

Magnetic stripe 120 may be coupled to back side 112 of substrate 110. Alternatively, magnetic stripe 120 may be coupled to front side 111, or magnetic stripes 120 may be coupled to both front side 111 and back side 112 of substrate 110. Magnetic stripe 120 may contain information such as an account number and/or any other desired information. Alternatively, magnetic stripe 120 may contain no information. Still alternatively, magnetic stripe 120 may be a fake or dummy stripe, such as a dark colored stripe which emulates the appearance of a magnetic stripe. For at least some applications, a fake or dummy stripe may be important as it may give magnetic stripe card 100 a higher perceived value than if there was no magnetic stripe at all, dummy or otherwise.

Magnet 130 may be coupled to back side 112 of substrate 110. Alternatively, magnet 130 may be coupled to front side 111 of substrate 110, or magnets 130 may be coupled to both front side 111 and back side 112 of substrate 110. Magnet 130 may be configured as a strip. Alternatively, magnet 130 may be configured as a rectangle, disc, and/or any other suitable shape.

Magnet 130 may be coupled with an adhesive or other suitable method. Magnet 130 may have alternating polarity, such as a Halbach array, or uniform polarity. Magnet 130 is attracted to ferromagnetic materials such as iron. Magnet 130 may be configured to be coupled or stuck to a ferromagnetic material, such as a refrigerator door. Magnet 130 may encourage the placement of magnetic stripe card 100 in a high traffic or high visibility area, and may enhance the usefulness of magnetic stripe card 100 as an advertisement or reminder.

Magnet 130 may have a magnetic pull force equal to or greater than that necessary to support a total weight of substrate 110, magnetic stripe 120, and magnet 130 when magnet 130 is coupled to a ferromagnetic material.

Magnet 130 may have a magnetic field strength less than which will affect information stored in magnetic stripe 120. Magnet 130 may have a magnetic field strength less than that which will affect information stored in other magnetic stripes similar to magnetic stripe 120. Magnet 130 may have a magnetic field strength less than that which will affect information stored in a magnetic stripe of an adjacent or stacked magnetic stripe card.

Alternatively, magnet 130 may have a magnetic field strength greater than that which will affect information stored in magnetic stripe 120, other magnetic stripes similar to magnetic stripe 120, and/or a magnetic stripe of an adjacent or stacked magnetic stripe card. This is because the information stored in magnetic stripe 120 may not be important, and/or may be stored or otherwise available elsewhere.

FIGS. 2A-2B show another embodiment of a magnetic stripe card 200. Magnetic stripe card 200 may be a gift card, credit card, debit card, stored value card, identification card, or any other card having a magnetic stripe. Magnetic stripe card 200 may include a substrate 210, a magnetic stripe 220, and at least one magnet 230.

Substrate 210 may be substantially flat. Substrate 210 may include a front side 211 and a back side 212. Substrate 210 may be substantially rectangular. Alternatively, substrate 210 may be any other suitable shape. Substrate 210 may be printed, embossed, and/or otherwise imparted with a business name, advertisement, account number, bar code, graphics, value indication, writeable area, and/or any other desired information. Substrate 210 may be rigid, semi-rigid, or flexible. Substrate 210 may be made of a plastic, metal, cardboard, paper, and/or any other suitable material. Substrate 210 may include at least one indentation 213 formed in back side 212 of substrate 210. Alternatively, substrate 210 may include at least one indentation 213 formed in front side 211, or in both front side 211 and back side 212 of substrate 210. Indentation 213 may be rectangular. Alternatively, indentation 213 may be circular or any other suitable shape.

Substrate 210 may have dimensions that substantially conform to CR80 or ISO/IEC 7810 ID-1. Substrate 210 may have dimensions of a standard credit card, or having a length and width of approximately 85.60 mm×53.98 mm and a thickness of approximately 0.76 mm. For at least some applications, the size of substrate 210 may be important as it may give magnetic stripe card 200 a higher perceived value than cards or tokens of other sizes. Alternatively, substrate 210 may have any suitable dimensions.

Magnetic stripe 220 may be coupled to back side 212 of substrate 210. Alternatively, magnetic stripe 220 may be coupled to front side 211, or magnetic stripes 220 may be coupled to both front side 211 and back side 212 of substrate 210. Magnetic stripe 220 may contain information such as an account number and/or any other desired information. Alternatively, magnetic stripe 220 may contain no information. Still alternatively, magnetic stripe 220 may be a fake or dummy stripe, such as a dark colored stripe which emulates the appearance of a magnetic stripe. For at least some applications, a fake or dummy stripe may be important as it may give magnetic stripe card 200 a higher perceived value than if there was no magnetic stripe at all, dummy or otherwise.

Magnet 230 may be coupled at least partially within indentation 213 of substrate 210. Magnet 230 may be coupled substantially flush to front side 211 or back side 212 of substrate 210. Magnet 230 may be configured as a strip. Alternatively, magnet 230 may be configured as a rectangle, disc, and/or any other suitable shape.

Magnet 230 may be coupled with an adhesive or other suitable method. Magnet 230 may have alternating polarity, such as a Halbach array, or uniform polarity. Magnet 230 is attracted to ferromagnetic materials such as iron. Magnet 230 may be configured to be coupled or stuck to a ferromagnetic material, such as a refrigerator door. Magnet 230 may encourage the placement of magnetic stripe card 200 in a high traffic or high visibility area, and may enhance the usefulness of magnetic stripe card 200 as an advertisement or reminder.

Magnet 230 may have a magnetic pull force equal to or greater than that necessary to support a total weight of substrate 210, magnetic stripe 220, and magnet 230 when magnet 230 is coupled to a ferromagnetic material.

Magnet 230 may have a magnetic field strength less than which will affect information stored in magnetic stripe 220. Magnet 230 may have a magnetic field strength less than that which will affect information stored in other magnetic stripes similar to magnetic stripe 220. Magnet 230 may have a magnetic field strength less than that which will affect information stored in a magnetic stripe of an adjacent or stacked magnetic stripe card.

Alternatively, magnet 230 may have a magnetic field strength greater than that which will affect information stored in magnetic stripe 220, other magnetic stripes similar to magnetic stripe 220, and/or a magnetic stripe of an adjacent or stacked magnetic stripe card. This is because the information stored in magnetic stripe 220 may not be important, and/or may be stored or otherwise available elsewhere.

FIGS. 3A-3B show yet another embodiment of a magnetic stripe card 300. Magnetic stripe card 300 may be a gift card, credit card, debit card, stored value card, identification card, or any other card having a magnetic stripe. Magnetic stripe card 300 may include a substrate 310, a magnetic stripe 320, and at least one magnet 330.

Substrate 310 may be substantially flat. Substrate 310 may include a front side 311 and a back side 312. Substrate 310 may be substantially rectangular. Alternatively, substrate 310 may be any other suitable shape. Substrate 310 may be printed, embossed, and/or otherwise imparted with a business name, advertisement, account number, bar code, graphics, value indication, writeable area, and/or any other desired information. Substrate 310 may be rigid, semi-rigid, or flexible. Substrate 310 may be made of a plastic, metal, and/or any other suitable material. Substrate 310 may include at least one hole 313 formed in substrate 310. Hole 313 may be circular. Alternatively, hole 313 may be rectangular or any other suitable shape.

Substrate 310 may have dimensions that substantially conform to CR80 or ISO/IEC 7810 ID-1. Substrate 310 may have dimensions of a standard credit card, or having a length and width of approximately 85.60 mm×53.98 mm and a thickness of approximately 0.76 mm. For at least some applications, the size of substrate 310 may be important as it may give magnetic stripe card 300 a higher perceived value than cards or tokens of other sizes. Alternatively, substrate 310 may have any suitable dimensions.

Magnetic stripe 320 may be coupled to back side 312 of substrate 310. Alternatively, magnetic stripe 320 may be coupled to front side 311, or magnetic stripes 320 may be coupled to both front side 311 and back side 312 of substrate 310. Magnetic stripe 320 may contain information such as an account number and/or any other desired information. Alternatively, magnetic stripe 320 may contain no information. Still alternatively, magnetic stripe 320 may be a fake or dummy stripe, such as a dark colored stripe which emulates the appearance of a magnetic stripe. For at least some applications, a fake or dummy stripe may be important as it may give magnetic stripe card 300 a higher perceived value than if there was no magnetic stripe at all, dummy or otherwise.

Magnet 330 may be coupled at least partially within hole 313 of substrate 310. Magnet 330 may be coupled substantially flush to front side 311 and/or back side 312 of substrate 310. Magnet 330 may be configured as a disc. Alternatively, magnet 330 may be configured as a rectangle, strip, and/or any other suitable shape.

Magnet 330 may be coupled with an adhesive or other suitable method. Magnet 330 may have alternating polarity, such as a Halbach array, or uniform polarity. Magnet 330 is attracted to ferromagnetic materials such as iron. Magnet 330 may be configured to be coupled or stuck to a ferromagnetic material, such as a refrigerator door. Magnet 330 may encourage the placement of magnetic stripe card 300 in a high traffic or high visibility area, and may enhance the usefulness of magnetic stripe card 300 as an advertisement or reminder.

Magnet 330 may have a magnetic pull force equal to or greater than that necessary to support a total weight of substrate 310, magnetic stripe 320, and magnet 330 when magnet 330 is coupled to a ferromagnetic material.

Magnet 330 may have a magnetic field strength less than which will affect information stored in magnetic stripe 320. Magnet 330 may have a magnetic field strength less than that which will affect information stored in other magnetic stripes similar to magnetic stripe 320. Magnet 330 may have a magnetic field strength less than that which will affect information stored in a magnetic stripe of an adjacent or stacked magnetic stripe card.

Alternatively, magnet 330 may have a magnetic field strength greater than that which will affect information stored in magnetic stripe 320, other magnetic stripes similar to magnetic stripe 320, and/or a magnetic stripe of an adjacent or stacked magnetic stripe card. This may be because the information stored in magnetic stripe 320 is not important, and/or may be stored or otherwise available elsewhere.

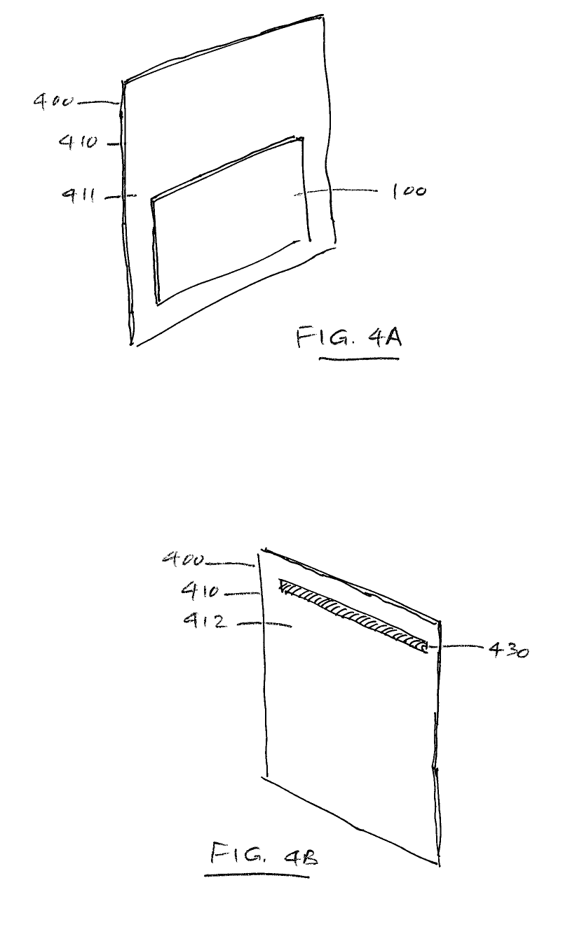

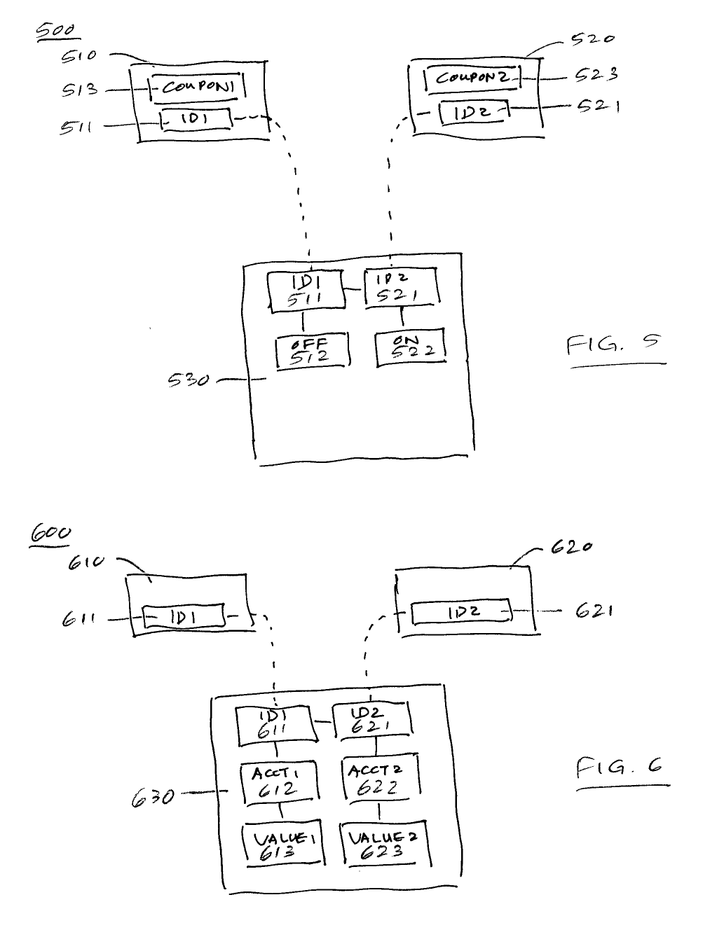

FIGS. 4A-4B show one embodiment of a backing 400 coupled to magnetic stripe card 100. Backing 400 may be configured to be coupled to magnetic stripe card 100, magnetic stripe card 200, magnetic stripe card 300, or any card or number of cards, with or without a magnetic stripe, and with or without a magnet. Backing 400 may include a mount 410 and a magnet 430.

Mount 410 may include a front side 411 and a back side 412. Magnetic stripe card 100 or other card may be coupled to front side 411 or back side 412 of mount 410. Mount 410 may be coupled to magnetic stripe card 100 or other card with an adhesive, staple, fastener, clip, cut, slit, pocket, or any other suitable method and/or device. Mount 410 may be substantially rectangular. Alternatively, mount 410 may be any other suitable shape. Mount 410 may be printed, embossed, and/or otherwise imparted with a business name, advertisement, account number, bar code, graphics, value indication, writeable area, and/or any other desired information. Mount 410 may be rigid, semi-rigid, or flexible. Mount 410 may be made of a plastic, metal, cardboard, paper, and/or any other suitable material.

Mount 410 may have a similar or different size as magnetic stripe card 100 or other card coupled to mount 410.

Magnet 430 may be coupled to back side 412 of mount 410. Alternatively, magnet 430 may be coupled to front side 411 of mount 410, or magnets 430 may be coupled to both front side 411 and back side 412 of mount 410. Magnet 430 may be configured as a strip. Alternatively, magnet 430 may be configured as a rectangle, disc, and/or any other suitable shape.

Magnet 430 may be coupled with an adhesive or other suitable method. Magnet 430 may have alternating polarity, such as a Halbach array, or uniform polarity. Magnet 430 is attracted to ferromagnetic materials such as iron. Magnet 430 may be configured to be coupled or stuck to a ferromagnetic material, such as a refrigerator door. Magnet 430 may encourage the placement of magnetic stripe card 100 or other card coupled to mount 410 in a high traffic or high visibility area, and may enhance the usefulness of magnetic stripe card 100 or other card coupled to mount 410 as an advertisement or reminder.

Magnet 430 may have a magnetic pull force equal to or greater than that necessary to support a total weight of magnetic stripe card 100 or other card coupled to mount 410, as well as a total weight of backing 400 when magnet 430 is coupled to a ferromagnetic material.

Magnet 430 may have a magnetic field strength less than which will affect information stored on magnetic stripe card 100 or other card coupled to mount 410.

Alternatively, magnet 430 may have a magnetic field strength greater than that which will affect information stored on magnetic stripe card 100 or other card coupled to mount 410. This is because the information stored on magnetic stripe card 100 or other card coupled to mount 410 may not be important, and/or may be stored or otherwise available elsewhere.

FIG. 5 shows one embodiment of a system 500 for rewarding referrals. System 500 may include a first card 510, a second card 520, and a server 530.

First card 510 may be a magnetic stripe card 100, magnetic stripe card 200, magnetic stripe card 300, or any other suitable card, with or without a magnetic stripe, and with or without a magnet. First card 510 may be associated with a first identifier 511, a first switch 512, and a first coupon 513. First identifier 511 may include a unique number, an alphanumeric sequence, a name of an existing patient or customer, or other suitable identifier. First identifier 511 may be written, printed, or otherwise visible on first card 510. First switch 512 may include one or more tags which indicate whether first coupon 513 is available for use. For example, first switch 512 may include tags such as “off” and “on”, or “unavailable” and “available”. First switch 512 may include one or more additional tags such as “unknown”. First coupon 513 may include a dollar discount, a percentage discount, or other suitable incentive. First coupon 513 may be written, printed, or otherwise visible on first card 510. First switch 512 may initially be set to indicate that first coupon 513 is not available for use.

Second card 520 may be associated with first card 510. In addition, one or more additional cards may also be associated with first card 510. Second card 520 may be removably coupled to first card 510. Second card 520 may be a magnetic stripe card 100, magnetic stripe card 200, magnetic stripe card 300, or any other suitable card, with or without a magnetic stripe, and with or without a magnet. Second card 520 may be associated with a second identifier 521, a second switch 522, and a second coupon 523. Second identifier 521 may include a unique number, an alphanumeric sequence, a name of an existing patient or customer, or other suitable identifier. Second identifier 521 may be written, printed, or otherwise visible on second card 520. Second identifier 521 may be the same or different as first identifier 511. Second switch 522 may include one or more tags which indicate whether second coupon 523 is available for use. For example, second switch 522 may include tags such as “off” and “on”, or “unavailable” and “available”. Second switch 522 may include one or more additional tags such as “unknown”. Second coupon 523 may include a dollar discount, a percentage discount, or other suitable incentive. Second coupon 523 may be written, printed, or otherwise visible on second card 520. Second switch 522 may be initially set to indicate that second coupon 523 is available for use. Second coupon 523, when used, may change first switch 512 to indicate that first coupon 513 is available for use.

First card 510 and second card 520 may have dimensions that substantially conform to CR80 or ISO/IEC 7810 ID-1. First card 510 and second card 520 may have dimensions of a standard credit card, or having a length and width of approximately 85.60 mm×53.98 mm and a thickness of approximately 0.76 mm. For at least some applications, the sizes of first card 510 and second card 520 may be important as it may give first card 510 and second card 520 a higher perceived value than cards or tokens of other sizes. Alternatively, first card 510 and second card 520 may have any suitable dimensions, and/or may be of different sizes.

Server 530 may include a computer with appropriate software. Server 530 may be configured to receive and store first identifier 511 and second identifier 521. Server 530 may also be configured to receive and store additional information, such as a date first card 510 and second card 520 were distributed. Server 530 may be configured to associate first card 510 with second card 520. In one embodiment, may associate first card 510 with second card 520 by associating first identifier 511 with second identifier 521. Server 530 may be configured to initially set first switch 512 to indicate that first coupon 513 is not available for use. Server 530 may be configured to initially set second switch 522 to indicate that second coupon 523 is available for use.

Alternatively, server 530 may be configured to initially set second switch 522 to indicate that second coupon 523 is not available for use. Server 530 may be configured to receive contact information associated with second card 520. The contact information may include name, phone number, street address, e-mail address, or other suitable information. When server 530 receives contact information associated with second card 520, server 530 may be configured to change second switch 522 to indicate that second coupon 523 is available for use. Server 530 may be configured to provide the contact information when accessed.

Server 530 may be configured to receive a notice when first coupon 513 and/or second coupon 523 has been used. When server 530 receives a notice that second coupon 523 has been used, server 530 may be configured to change first switch 512 to indicate that first coupon 513 is now available for use. Server 530 may also change second switch 522 to indicate that second coupon 523 is no longer available for use. When server 530 receives a notice that first coupon 513 has been used, server 530 may be configured to change first switch 512 to indicate that first coupon 513 is no longer available for use. Server 530 may not be configured to store any information about first coupon 513 and/or second coupon 523, other than first switch 512 and second switch 522.

As an example, a dentist may give an existing patient a first card 510 and a second card 520. First card 510 and second card 520 may be associated with first coupon 513 and second coupon 523, respectively, such as a percentage discount (same or different) which may be used toward dental services. First card 510 may be intended for use by the existing patient, while second card 520 may be intended for use by a new patient. The dentist may access server 530 and enter first identifier 511 and second identifier 521. Server 530 may receive and store first identifier 511 and second identifier 521. Server 530 may also receive and store additional information, such as a date first card 510 and second card 520 were given to the existing patient. Server 530 may associate first card 510 and second card 520 by associating first identifier 511 and second identifier 521. Server 530 may initially set first switch 512 to indicate that first coupon 513 is not available for use. Server 530 may initially set second switch 522 to indicate that second coupon 523 is available for use.

The existing patient gives second card 520 to a new patient as an incentive to visit the dentist. Second coupon 523 may be available for use. Alternatively, server 530 may initially set second switch 522 to indicate that second coupon 523 is not available for use. The new patient may be required to first register or activate second card 520 before second coupon 523 is available for use. For example, the new patient may be required to access server 530 and enter contact information for the new patient. When server 530 receives and stores the contact information, server 530 may then set second switch 522 to indicate that second coupon 523 is now available for use. The dentist may access server 530 to obtain the contact information for the new patient to call and/or send marketing materials, or to remind or encourage the new patient to visit the dentist.

The new patient visits the dentist and presents second card 520 to redeem second coupon 523. The dentist may access server 530 to send a notice to server 530 that second coupon 523 has been used. When server 530 receives the notice that second coupon 523 has been used, server 530 may be configured to require that a name of the new patient be entered as part of the notice, if second card 520 has not been already registered or activated. Server 530 may be configured to check that the name of the new patient is different than the name of the existing patient, or otherwise verify that the patient holding first card 510 is different than the patient holding second card 520. When server 530 receives a notice that second coupon 523 has been used, server 530 may change first switch 512 to indicate that first coupon 513 is now available for use. Server 530 may also change second switch 522 to indicate that second coupon 523 is no longer available for use.

The existing patient may then visit the dentist and present first card 510 to redeem first coupon 513. The dentist may access server 530 to send a notice to server 530 that first coupon 513 has been used. When server 530 receives the notice that first coupon 513 has been used, server 530 may change first switch 512 to indicate that first coupon 513 is no longer available for use.

FIG. 6 shows another embodiment of a system 600 for rewarding referrals. System 600 may include a first card 610, a second card 620, and a server 630.

First card 610 may be a magnetic stripe card 100, magnetic stripe card 200, magnetic stripe card 300, or any other suitable card, with or without a magnetic stripe, and with or without a magnet. First card 610 may be associated with a first identifier 611, a first account 612, and a first value 613. First identifier 611 may include a unique number, an alphanumeric sequence, a name of an existing patient or customer, or other suitable identifier. First identifier 611 may be written, printed, or otherwise visible on first card 610. First account 612 may be used to store first value 613. First value 613 may include a dollar amount. First account 612 may initially be set to have a first value 613 of zero.

Second card 620 may be associated with first card 610. In addition, one or more additional cards may also be associated with first card 610. Second card 620 may be removably coupled to first card 610. Second card 620 may be a magnetic stripe card 100, magnetic stripe card 200, magnetic stripe card 300, or any other suitable card, with or without a magnetic stripe, and with or without a magnet. Second card 620 may be associated with a second identifier 621 and a second account 622. Second card 620 may also be associated with a second value 623. Alternatively, second card 620 may be associated with a coupon, such as those described in system 400. Second identifier 621 may include a unique number, an alphanumeric sequence, a name of an existing patient or customer, or other suitable identifier. Second identifier 621 may be written, printed, or otherwise visible on second card 620. Second identifier 621 may be the same or different as first identifier 611. Second account 622 may be used to store second value 623. Second value 623 may include a dollar amount. Second account 622, when used, may cause value to be added to first account 612. Second account 622 may be set to have some initial value.

First card 610 and second card 620 may have dimensions that substantially conform to CR80 or ISO/IEC 7810 ID-1. First card 610 and second card 620 may have dimensions of a standard credit card, or having a length and width of approximately 85.60 mm×63.98 mm and a thickness of approximately 0.76 mm. For at least some applications, the sizes of first card 610 and second card 620 may be important as it may give first card 610 and second card 620 a higher perceived value than cards or tokens of other sizes. Alternatively, first card 610 and second card 620 may have any suitable dimensions, and/or may be of different sizes.

Server 630 may include a computer with appropriate software. Server 630 may be configured to receive and store first identifier 611 and second identifier 621. Server 630 may also be configured to receive and store additional information, such as a date first card 610 and second card 620 were distributed. Server 630 may be configured to associate first card 610 with second card 620. In one embodiment, may associate first card 610 with second card 620 by associating first identifier 611 with second identifier 621. Server 630 may be configured to initially set first account 612 to have a first value 613 of zero. Server 630 may be configured to set second account 622 to have some initial value.

Alternatively, server 630 may be configured to initially set second account 622 to have a second value 623 of zero. Server 630 may be configured to receive contact information associated with second card 620. The contact information may include name, phone number, street address, e-mail address, or other suitable information. When server 630 receives contact information associated with second card 620, server 630 may be configured to cause value to be added to second account 622. Server 630 may be configured to provide the contact information when accessed.

Server 630 may be configured to receive a notice when first account 612 and/or second account 622 has been used. When server 630 receives a notice that second account 622 has been used, server 630 may be configured to cause value to be added to first account 612, on a one-to-one basis or any desired ratio. Server 630 may also cause value to be deducted from second account 622. When server 630 receives a notice that first account 612 has been used, server 630 may be configured to cause value to be deducted from first account 612.

As an example, a dentist may give an existing patient a first card 610 and a second card 620. First card 610 and second card 620 may be associated with a first value 613 and a second value 623, respectively, such as a dollar amount (same or different) which may be used toward dental services. First card 610 may be intended for use by the existing patient, while second card 620 may be intended for use by a new patient. The dentist may access server 630 and enter first identifier 611 and second identifier 621. Server 630 may receive and store first identifier 611 and second identifier 621. Server 630 may also receive and store additional information, such as a date first card 610 and second card 620 were given to the existing patient. Server 630 may associate first card 610 and second card 620 by associating first identifier 611 and second identifier 621. Server 630 may initially set first account 612 to have a first value 613 of zero. Server 630 may set second account 622 to have second value 623 of some initial value.

The existing patient gives second card 620 to a new patient as an incentive to visit the dentist. Second account 622 may have second value 623 of some initial value. Alternatively, server 630 may initially set second account 622 to have second value 623 of zero. The new patient may be required to first register or activate second card 620 before second account 622 has some value. For example, the new patient may be required to access server 630 and enter contact information for the new patient. When server 630 receives and stores the contact information, server 630 may then cause value to be added to second account 622. The dentist may access server 630 to obtain the contact information for the new patient to call and/or send marketing materials, or to remind or encourage the new patient to visit the dentist.

The new patient visits the dentist and presents second card 620 to use second account 622. The dentist may access server 630 to send a notice to server 630 that second account 622 has been used. When server 630 receives the notice that second account 622 has been used, server 630 may be configured to require that a name of the new patient be entered as part of the notice, if second card 620 has not been already registered or activated. Server 630 may be configured to check that the name of the new patient is different than the name of the existing patient, or otherwise verify that the patient holding first card 610 is different than the patient holding second card 620. When server 630 receives a notice that second account 622 has been used, server 630 may cause value to be added to first account 612, on a one-to-one basis or any desired ratio. Server 630 may also deduct value from second account 622.

The existing patient may then visit the dentist and present first card 610 to use first account 612. The dentist may access server 630 to send a notice to server 630 that first account 612 has been used. When server 630 receives the notice that first account 612 has been used, server 630 may cause value to be deducted from first account 612.

While the foregoing has been with reference to particular embodiments of the invention, it will be appreciated by those skilled in the art that changes in these embodiments may be made without departing from the principles and spirit of the invention.

What is claimed is:

1. A magnetic stripe card configured to be coupled to a ferromagnetic material, the magnetic stripe card comprising:
a substrate;
a magnetic stripe coupled to the substrate;
at least one magnet coupled to the substrate, the magnet having a magnetic pull force equal to or greater than that necessary to support a total weight of the substrate, the magnetic stripe, and the magnet when coupled to the ferromagnetic material.

2. The magnetic stripe card of claim 1, wherein the magnet has a magnetic field strength less than that which will affect information stored in the magnetic stripe or other magnetic stripes similar to the magnetic stripe.

3. The magnetic stripe card of claim 1, wherein the substrate includes a front side and a back side, and wherein the magnet is coupled to the front side and/or the back side.

4. The magnetic stripe card of claim 1, wherein the substrate includes at least one indentation, and wherein the magnet is coupled at least partially within the indentation.

5. The magnetic stripe card of claim 1, wherein the substrate includes at least one hole, and wherein the magnet is coupled at least partially within the hole.

6. A system for rewarding referrals, the system comprising:
a first card having a first coupon associated with the first card, the first coupon not initially available for use; and
a second card associated with the first card, the second card having a second coupon associated with the second card;
wherein use of the second coupon associated with the second card causes the first coupon associated with the first card to become available for use.

7. The system of claim 6, wherein the first coupon and/or the second coupon includes a dollar discount.

8. The system of claim 6, wherein the first coupon and/or the second coupon includes a percentage discount.

9. A method for rewarding referrals, the method comprising:
receiving a first identifier associated with a first card, the first card being associated with a first coupon, the first coupon not initially available for use;
receiving a second identifier associated with a second card, the second card being associated with a second coupon;
associating the first card with the second card;
receiving a notice that the second coupon associated with the second card has been used; and
making the first coupon associated with the first card available for use.

10. The method of claim 9, wherein the first identifier and the second identifier are different.

11. The method of claim 9, wherein the first identifier and the second identifier are the same.

12. The method of claim 9, wherein the first identifier includes a unique number or alphanumeric sequence.

13. The method of claim 9, wherein the first identifier includes a name of a existing user.

14. The method of claim 13, wherein receiving a notice includes receiving a name of a new user.

15. The method of claim 14, wherein receiving a notice includes checking that the name of the new user is different than the name of the existing user.
